(19) United States
(12) Patent Application Publication
(10) Pub. No.: US 2001/0020771 A1
(43) Pub. Date: Sep. 13, 2001

(54) Seal device for a shaft

(76) Inventor: Hirotoshi Nishikawa, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 09/796,464

(22) Filed: Mar. 2, 2001

(30) Foreign Application Priority Data
Mar. 7, 2000 (JP) 2000-62014

(51) Int. Cl. F16J 15/18

(52) U.S. Cl. 277/511

(57) ABSTRACT

A seal device for a shaft is provided which has a maintenance seal which can reliably seal around the shaft without compression by rotation or pressing force, and which eliminates the necessity of readjustment after replacement of the seal packings. A seal packing is retained in a packing case housed in a casing, and a maintenance seal is housed under the packing case. A pressurizing means resiliently deforms a resilient body fitted so as to form a sealed space. The pressurizing means supplies pressurized fluid into the sealed space and inflates the resilient body to press it against the shaft. The pressurized fluid is discharged after repair of seal packings.

### BACKGROUND OF THE INVENTION

This invention relates to a seal device for a shaft such as a valve shaft, and particularly to a seal device having a maintenance seal used during repair of a seal packing.

A seal packing such as a gland packing is ordinarily mounted in a portion where a shaft such as a valve shaft passes through a casing such as a valve box in order to prevent leakage of a fluid in piping such as water to outside. Since such a seal packing is damaged due e.g. to wear and frictional heat during sliding, repair such as replacement is necessary. For repair of such a seal packing, in order to prevent leakage of the fluid to outside, it was necessary to stop the operation of the system and drain the fluid from the piping.

In order to eliminate such a shutdown, with a shutoff valve disclosed in Japanese patent publication 8-312833, the structure shown in FIG. 4 is employed. In order to seal a hole 33 for a valve shaft 32 provided in a casing 31, the casing is provided with a packing-receiving portion 35 formed with female threads 34 on its inner surface and a seal 36 for maintenance is received in the bottom of the packing-receiving portion 35 so as to surround the valve shaft 32. A packing case 38 formed with male threads 37 on its outer surface is housed on the seal 36 and threadedly engages the female threads 34 of the portion 35. A plurality of seal packings 39 are mounted on the valve shaft 32 in the packing case 38.

Over the packing case 38, a packing gland 40 is pressed against the top face of the seal packing 39. Bolts 45 having male threads 44 and 44′ at both ends extend through bolt holes 42 formed in a flange portion 41 of the packing gland 40 and threaded holes 43 formed in a flange portion 41′ of the packing-receiving portion 35 and are tightened in a vertical direction by nuts 46 and 46′. Thus, the seal packings 39 are pressed in the packing case 38 to seal the hole 33.

On the other hand, when necessity of repair of the seal packings 39 arises, by threading the packing case 38 downwardly, the seal 36 for maintenance will be deformed inwardly by compression into close contact with the outer peripheral surface of the valve shaft 32. Thus, the hole 33 is sealed, so that infiltration of fluid in the piping into the packing-receiving portion 35 is prevented.

Thus, by loosening and removing the nuts 46 from the bolts 45 and removing the packing gland 40 by pulling it up, the seal packings 39 can be taken out of the packing case 38 to replace them with new packings.

After completion of repair, when the packing case 38 is returned to its original position, pressing force on the seal 36 for maintenance is relaxed, so that deterioration of the seal due to contact with the shaft is prevented.

But with the seal means described in the above publication, since the maintenance seal 36 is pressed toward the valve shaft 32 as the packing case 38 turns, twisting and compression develop in the seal 36, so that it will not be uniformly pressed against the outer peripheral surface of the valve shaft 32. Thus, seal of the hole 33 will be insufficient and the seal life is shortened.

Also, even if you try to deform the maintenance seal 36 inwardly by compression-deforming it toward the valve shaft, it is difficult to deform. If attempts are made to forcibly deform it by increasing the turning pressing force, the seal 36 might be damaged.

Further, after completion of repair, when the packing case 38 is loosened and returned to its original position, the amount of pressing on the seal packings 39 changes. Therefore, readjustment of pressing force on the seal packings 39 is necessary.

An object of this invention is to provide a seal device for a shaft such as a valve shaft which is provided with a maintenance seal which can reliably seal around the shaft without requiring compression by rotating or pressing force, and which eliminates the necessity of readjustment after replacement of seal packings.

### SUMMARY OF THE INVENTION

According to the present invention, there is provided a seal device for a shaft such as a valve shaft comprising a casing through which the shaft such as a valve shaft is passed, a packing case mounted in the casing, a seal packing retained in the packing case, a maintenance seal housed in the casing axially inwardly of the seal packing, and a pressurizing means for resiliently deforming the maintenance seal and pressing it against the shaft during repair of the seal packing to seal around the shaft, the maintenance seal having a resilient body fitted in the casing so as to form a sealed space around the shaft, and the pressurizing means being structured to supply pressurized fluid into the sealed space to inflate the resilient body to press it against the shaft to seal around the shaft.

With this structure, the resilient body is inflated by pressurized fluid supplied into the sealed space of the maintenance seal, so that the shaft passing portion can be reliably sealed. Thus it is possible to carry out repair of the seal packing without draining fluid in the piping. There is no need to stop the operation of the system.

Since the resilient body is simply inflated with no twisting or compressive deformation, the seal life prolongs.

Further, after completion of repair of the seal packing, the resilient body shrinks due to its resilience by stopping the supply of pressurized fluid, and returns to the state before the supply of pressurized fluid. Thus, there is no need to readjust the pressing force of the seal packing.

The maintenance seal may be provided between the packing case and the inner bottom surface of the casing, and the maintenance seal comprises the resilient body and a retaining ring, and the resilient body extend from the surface of the retaining ring on the side of the packing case through its inner peripheral surface to the surface of the retaining ring on the side of the bottom of the casing, and that the sealed space is formed by pressing the packing case against the retaining ring.

With this structure, since both sides of the retaining ring are sealed, a sealed space is formed. As a result, by the action of pressurized fluid, the resilient body is reliably inflated to seal around the shaft.

The resilient body has both ends thereof reaching the outer peripheral surface of the retaining ring and clamped by the retaining ring.

With this arrangement, since the outer peripheral surface of the retaining ring is also sealed, the resilient body is securely fitted by the retaining ring. Since the sealed space is formed simultaneously, the resilient body is inflated while pressurized fluid is being supplied. When the supply of pressurized fluid is stopped, the resilient body shrinks and the pressurized fluid in the sealed space is discharged. This action is reliably repeated during each repair of the seal packing. As a result, the sealability around the shaft improves, so that the seal life also improves.

The retaining ring may be formed with a hole for communicating a pressurized fluid supply source outside the casing with the sealed space.

In a normal state in which pressurized fluid is not supplied, a gap is formed between the inner peripheral surface of the resilient body and the outer peripheral surface of the shaft.

By this gap, since the resilient body is normally out of contact with the shaft, the resilient body will hardly wear or deteriorate, and the seal life prolongs. Also, frictional resistance by the seal surface will not act on the shaft, so that the load on the shaft decreases.

A liner may be disposed between the maintenance seal and the bottom surface of the packing housing.

A liner is disposed between the maintenance seal and the bottom surface of the packing housing.

The pressurized fluid may be pressurized air.

Other features and objects of the present invention will become apparent from the following description made with reference to the accompanying drawings, in which:

### BRIEF DESCRIPTION OF THE DRAWINGS

FIG. 1 is a sectional view of a butterfly valve of an embodiment;

FIG. 2 is a partially omitted sectional view of the seal device in a normal state;

FIG. 3 is a partially omitted sectional view of the seal device during repair; and

FIG. 4 is a partially omitted sectional view of a prior art seal device.

### DETAILED DESCRIPTION OF THE PREFERRED EMBODIMENT

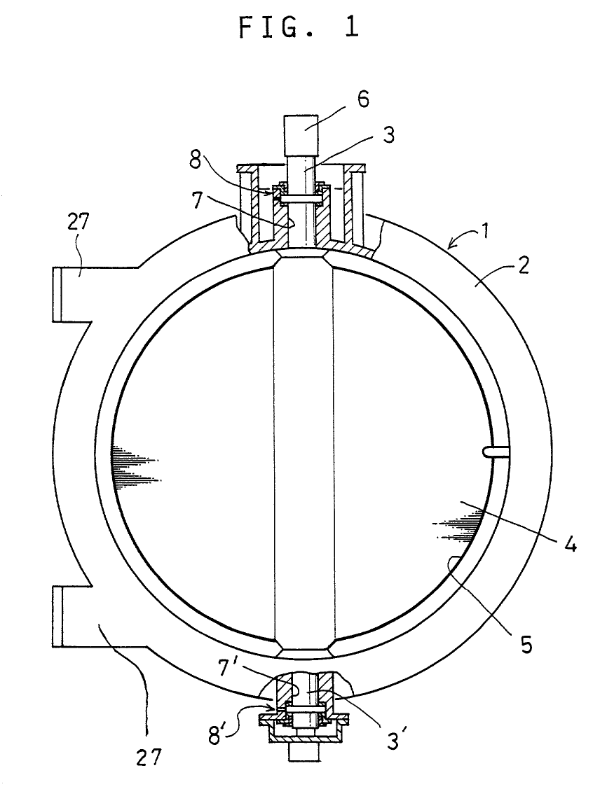

The embodiment of this invention will be described with reference to from FIG. 1 to FIG. 3.

FIG. 1 shows a butterfly valve 1 in which the seal device 8 of this invention is mounted. In this butterfly valve 1, at the top and bottom portions of a casing 2, valve shafts 3, 3′ pass through the casing 2, and a valve body 4 is mounted on the valve shafts 3, 3′. A rubber seat 5 is mounted on the inner peripheral surface of the casing 2. A manual or automatic on-off device is coupled to a coupling portion 6 at the top end of the valve shaft 3. By operating it, the valve shafts 3, 3′ turn and the valve body 4 is opened and closed to adjust the flow rate of fluid such as water in the piping.

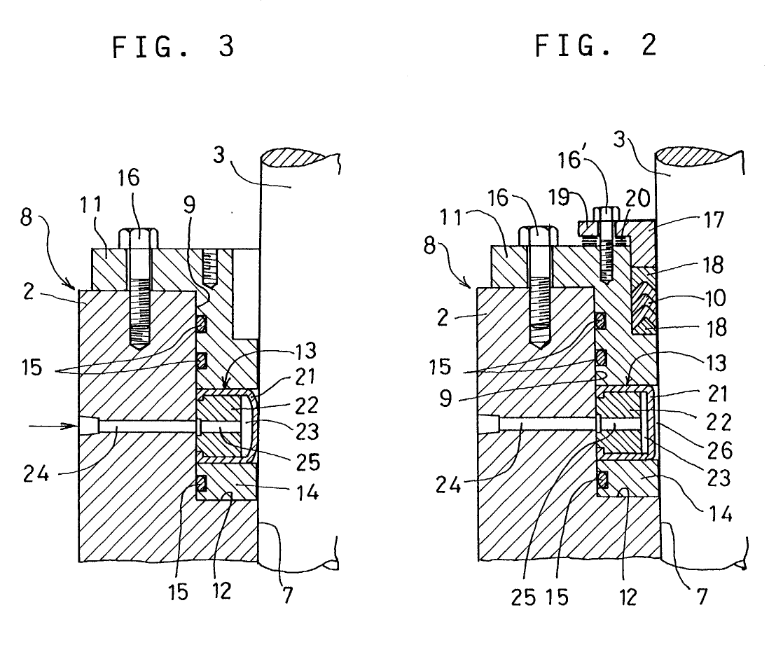

In order to prevent fluid in the piping from leaking through portions 7, 7′ through which the valve shafts 3, 3′ pass, seal devices 8, 8′ for the valve shafts 3, 3′ are provided at top and bottom of the butterfly valve 1. As shown in detail in FIG. 2, the seal device 8 for the valve shaft 3 at the top has a packing case 11 housed in a packing housing portion 9 provided axially outwardly of the shaft passing portion 7 and fixed by bolts 16. A seal packing 10 (gland packing) is retained therein. In the seal housing portion 9, a maintenance seal 13 is housed axially inwardly of the seal packing 10 and under the packing case 11. Between the maintenance seal 13 and the bottom of the packing housing portion 9, a liner 14 is disposed. Also, on the outer peripheral surface of the packing case 11 and on the outer peripheral surface of the liner 14, O-rings 15 are fitted.

By disposing the liner 14, it is possible to improve the working accuracy of the contact surface with the maintenance seal 13 and thus sealability.

The seal packing 10 is pressed through adaptors 18 by a packing gland 17 mounted by bolts 16′ to the packing case 11. The pressed state is adjusted by changing the thickness of a shim 20 inserted between a flange 19 of the packing gland 17 and the top face of the packing case 11.

The maintenance seal 13 comprises a sheet-like resilient body 21 and a retaining ring 22 made of a metal. The resilient body 21 extends from the surface of the retaining ring 22 on the side of the packing case 11 through its inner peripheral surface to its surface on the side of the bottom surface 12. A sealed space 23 is formed by pressing the packing case 11 against the retaining ring 22. Enlarged both ends of the resilient body 21 reach the outer peripheral surface of the retaining ring 22 and are clamped between the retaining ring 22 and the inner peripheral surface of the packing housing portion 9.

The retaining ring 22 is provided with a hole 25 for communicating an external pressurized air supply source with the sealed space 23 through a passage 24 formed in the casing 2. Thus, pressurized air is supplied into the sealed space 23. In a normal state in which no pressurized air is supplied, a gap 26 is formed between the inner peripheral surface of the resilient body 21 and the outer peripheral surface of the valve shaft 3.

As the resilient body 21, a rubber seal may be used. As the material for the retaining ring 22, stainless steel may be used. The hole 25 is preferably formed substantially at the center of the width of the retaining ring 22. Legs 27 shown in FIG. 1 are provided for temporary placing on a floor for installation or maintenance.

The seal device 8′ for the valve shaft 3′ at the bottom also has the same structure as the seal device 8.

The operation of the embodiment of this invention, which has the above-described structure, will be described below.

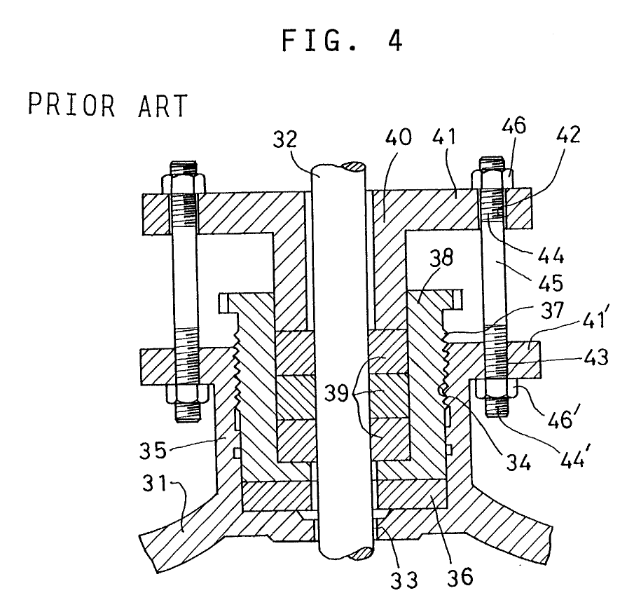

During repair of the seal packing 10, as shown by arrow in FIG. 3, when pressurized air is supplied through the passage 24 and the hole 25 into the sealed space 23, the inner peripheral surface of the resilient body 21 will inflate and be pressed against the valve shaft 3 to seal the portion 7 around the shaft. Thus the maintenance seal 13 has an inflatable structure in which seal is effected by inflating the resilient body 21 by filling pressurized air.

The pressure of the pressurized air must be equal to or slightly higher than the pressure of the fluid in the piping.

In the sealed state in which pressurized air has been supplied into the sealed space 23, fluid that passes through the butterfly valve 1 and the portion 7 will never flow toward the seal packing 10. Thus, even while fluid is flowing in the piping, it is possible to replace the seal packing 10 by loosening the bolts 16′ and dismounting the packing gland 17.

After repair has been completed by housing a new seal packing 10 in the packing case 11 and, as described above, adjusting the degree of pressing by the packing gland 17 and the shim 20, the supply of pressurized fluid is stopped. As shown in FIG. 2, the resilient body 21 will shrink and discharge air in the sealed space 23 to return to the state before the supply of pressurized fluid. The gap 26 is thus formed between the inner peripheral surface of the resilient body 21 and the outer peripheral surface of the valve shaft 3. Since the resilient body 21 is restored to its original position, it will have no influence on the pressing force of the seal packing. Thus it is not necessary to readjust the pressing force after repair.

The seal device is applicable not only to a butterfly valve, but to a ball valve, an eccentric valve or a shutoff valve. As the pressurizing fluid, instead of pressurized air, such a pressurized gas as nitrogen gas or pressurized water can also be used.

According to this invention, since the resilient body is pressed against the valve shaft by inflating it under pressurized fluid, it is possible to reliably seal the shaft passing portion. Thus, it is possible to repair the seal packing without discontinuing operation of the system.

What is claimed is:

1. A seal device for a shaft such as a valve shaft comprising a casing through which the shaft such as a valve shaft is passed, a packing case mounted in said casing, a seal packing retained in said packing case, a maintenance seal housed in said casing axially inwardly of said seal packing, and a pressurizing means for resiliently deforming said maintenance seal and pressing it against said shaft during repair of said seal packing to seal around the shaft, said maintenance seal having a resilient body fitted in said casing so as to form a sealed space around said shaft, and said pressurizing means being structured to supply pressurized fluid into said sealed space to inflate said resilient body to press it against the shaft to seal around said shaft.

2. The seal device as claimed in claim 1 wherein said maintenance seal is provided between said packing case and the inner bottom surface of said casing, and said maintenance seal comprises said resilient body and a retaining ring, and said resilient body extend from the surface of said retaining ring on the side of said packing case through its inner peripheral surface to the surface of said retaining ring on the side of the bottom of said casing, and that said sealed space is formed by pressing said packing case against said retaining ring.

3. The seal device as claimed in claim 1 or 2 wherein said resilient body has both ends thereof reaching the outer peripheral surface of said retaining ring and clamped by said retaining ring.

4. The seal device as claimed in any of claims 1-3 wherein said retaining ring is formed with a hole for communicating a pressurized fluid supply source outside said casing with said sealed space.

5. The seal device as claimed in any of claims 1-4 wherein while pressurized fluid is not supplied, a gap is formed between the inner peripheral surface of said resilient body and the outer peripheral surface of said shaft.

6. The seal device as claimed in any of claims 1-5 wherein a liner is disposed between said maintenance seal and the bottom surface of said packing housing.

7. The seal device as claimed in any of claims 1-6 wherein said pressurized fluid is pressurized air.
